(19) United States
(12) Patent Application Publication
(10) Pub. No.: US 2023/0230160 A1
(43) Pub. Date: Jul. 20, 2023

(54) SYSTEM FOR VISUALIZATION OF GRID CAPACITY OPERATION

(71) Applicant: Hitachi, Ltd., Tokyo (JP)

(72) Inventors: Masanori ABE, Santa Clara, CA (US); Bo YANG, Santa Clara, CA (US); Panitarn CHONGFUANGPRINYA, San Jose, CA (US); Yanzhu YE, San Jose, CA (US)

(21) Appl. No.: 17/579,287

(22) Filed: Jan. 19, 2022

(51) Int. Cl. G06Q 40/06

(52) U.S. Cl. CPC G06Q 40/06

(57) ABSTRACT

Example implementations described herein are directed to a visualization system and interface for identifying the pros and cons of new solutions of transmission grid management for each stakeholder. Systems and method described herein provide visualizations of pros and cons among stakeholders with respect to countermeasure operations for avoiding overloads to avoid overburdening or stakeholder bias.

### BACKGROUND

### Field

The present disclosure is generally directed to power grids, and more specifically, to systems and methods for addressing problems with providing visualizations of grid capacity.

### Related Art

In related art implementations, there are systems and methods for accurately determining real-time Available Transfer Capability (ATC) and the required ancillary service of large-scale interconnected power systems in an open-access transmission environment, subject to static and dynamic security constraints of a list of credible contingencies, including line thermal limits, bus voltage limits, voltage stability (steady-state stability) constraints, and transient stability constraints. Such example implementations provide a system to show real-time available transfer capability and required grid control resources, subject to static and dynamic security constraints of a list of credible contingencies.

In related art implementations, there is a real-time performance monitoring system for monitoring an electric power grid. The electric power grid has a plurality of grid portions, each grid portion corresponding to one of a plurality of control areas. The real-time performance monitoring system includes a monitor computer for monitoring at least one of reliability metrics, generation metrics, transmission metrics, suppliers metrics, grid infrastructure security metrics, and markets metrics for the electric power grid. The data for metrics being monitored by the monitor computer are stored in a data base, and a visualization of the metrics is displayed on at least one display computer having a monitor. The at least one display computer in one said control area enables an operator to monitor the grid portion corresponding to a different said control area.

Such related art implementations provide a visualization of real-time performance of operation and power flow.

### SUMMARY

Existing related art systems show only grid performance such as ATC, market prices, market trade, or market settlement. Existing related art systems do not have any function to tie between the value relationship of stakeholders except market information and grid simulation data since it cannot execute an estimation of value flows that has not yet been designed as a regulation, and cannot show economics relationship in real-time operation among stakeholders so that stakeholders cannot realize biased cons.

Further, the related art implementations fail to provide economic pros and cons relationship among stakeholders for applying a new operation. Additionally, the related art implementations cannot provide value flow among stakeholders for applying a new operation.

To address the issues of the related art, example implementations described herein involve systems and methods to visualize pros and cons among stakeholders of countermeasures operations for avoiding overloads can accelerate while introducing new types of non-wire solutions. To visualize pros and cons among many stakeholders, the example implementations further provide a system and method to handle visualized data to draw value flow among stakeholders on grid solutions.

In transmission grids, overloading is an increasing problem due to the rapid increase in renewable energy sources (RESs). For reducing investment on transmission facilities, unlocking transmission capacity by using real-time controlling grid components in a post-contingency situation can be provided as a solution for easing overloads. Control solutions can involve implementations such as not conventional only load shedding, generation re-dispatching, but also dynamic rating, transmission topology switching, power flow control with devices, and battery as a transmission. Such control could cause equipment deterioration, as well as loss of an electricity selling opportunity like generation curtailment at a time duration.

Thus, the coordination of interests among stakeholders involved in the operations will be necessary based on data analysis. Example implementations described herein can provide visualizations regarding the pros and cons among stakeholders of countermeasures operations for avoiding overloads so that the burden on a particular stakeholder is not biased.

To visualize value flow, the example implementations described herein involve systems and methods to calculate value flow of the pros and cons among stakeholders on actual or potential grid operation by logs and grid simulation, as well as visualize stakeholders value flow paths with alerts if the benefit of a stakeholder group is so much more biased compared to a threshold.

Aspects of the present disclosure can involve a method, which can involve calculating revenue gain or loss between stakeholders on grid operations based on logs associated with a grid and simulations executed on the grid; and generating a visualization of value flow paths between the stakeholders associated with the revenue gain or loss, the generating the visualization comprising consolidating value flows paths between pairs of stakeholders into a simplified representation.

Aspects of the present disclosure can involve a computer program, which can involve instructions involving calculating revenue gain or loss between stakeholders on grid operations based on logs associated with a grid and simulations executed on the grid; and generating a visualization of value flow paths between the stakeholders associated with the revenue gain or loss, the generating the visualization comprising consolidating value flows paths between pairs of stakeholders into a simplified representation. The computer program and instructions can be stored on a non-transitory computer readable medium and executed by one or more processors.

Aspects of the present disclosure can involve a system, which can involve means for calculating revenue gain or loss between stakeholders on grid operations based on logs associated with a grid and simulations executed on the grid; and means for generating a visualization of value flow paths between the stakeholders associated with the revenue gain or loss, the generating the visualization comprising consolidating value flows paths between pairs of stakeholders into a simplified representation.

Aspects of the present disclosure can involve an apparatus, which can involve a processor, configured to calculate revenue gain or loss between stakeholders on grid operations based on logs associated with a grid and simulations executed on the grid; and generate a visualization of value flow paths between the stakeholders associated with the revenue gain or loss, the generating the visualization comprising consolidating value flows paths between pairs of stakeholders into a simplified representation.

### BRIEF DESCRIPTION OF DRAWINGS

FIG. 1 illustrates an example of the transmission capacity in a power grid.

FIG. 2 illustrates an example overview of a capacity increase options by grid automation.

FIG. 3 illustrates a system overview, in accordance with an example implementation.

FIG. 4 illustrates an example overview of a value flow for a stakeholder, in accordance with an example implementation.

FIG. 5 illustrates an example data table for the value flow, in accordance with an example implementation.

FIG. 6 illustrates an overview of the value flow creation, in accordance with an example implementation.

FIG. 7 illustrates an example of value flow visualization, in accordance with an example implementation.

FIGS. 8(A) to 8(C) illustrate example simplifications of the value flow visualization on the dashboard, in accordance with an example implementation.

FIG. 9 illustrates an example visualization on path between two stakeholders, in accordance with an example implementation.

FIGS. 10(A) to 10(C) illustrate a visualization of a hierarchical view of value flows, in accordance with an example implementation.

FIG. 11(A) and 11(B) illustrates an example aggregation of value flows, in accordance with an example implementation.

FIGS. 12 and 13 illustrate a comparison view of a flow amount among stakeholders, in accordance with an example implementation.

FIG. 14 illustrates an example flow animation, in accordance with an example implementation.

FIG. 15 illustrates the flow animation cycle, in accordance with an example implementation.

FIG. 16 illustrates an example of the bias calculation flow, in accordance with an example implementation.

FIG. 17 illustrates an example of the bias visualization, in accordance with an example implementation.

FIG. 18(A) and 18(B) illustrate a map view of the dashboard, in accordance with an example implementation.

FIG. 19 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In the present disclosure, the following abbreviations will be used. GP: Generation Provider, LSE: Load Service Entity, TP: Transmission Provider, AG: Aggregator, PC: Power Consumer.

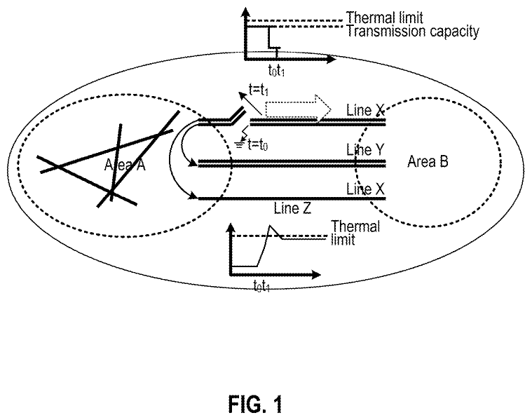

FIG. 1 illustrates an example of the transmission capacity in a power grid. In an online grid control system, actions in post-contingency are predetermined by simulation. For example, if a fault occurs at time t=t0 open the transmission line connection at time t=t1 via a protective relay. The power flows transmitted on the transmission line X before t0 flows around to other transmission lines. If the power flow on transmission line Z exceed the limits on safe operation of the grids, the power flow capacity of line X should be reduced.

The minimum value of the capacities calculated for a group of assumed faults is the available transmission capacity of the line X. This is the ordinal scheme used to determine power flow capacity by grid security conditions in a post-contingency situation. Examples of conditions can involve post-contingency overload (e.g., for in short, 15 min, 4 hour), voltage oscillation and deviation, transient stability, and so on.

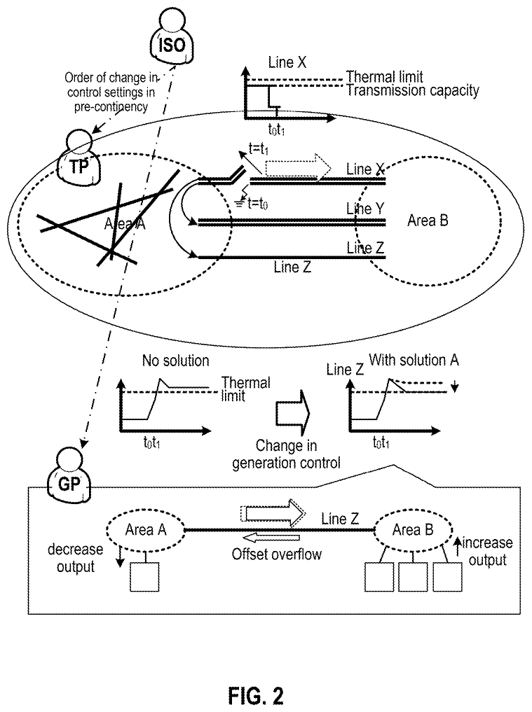

FIG. 2 illustrates an example overview of a capacity increase options by grid automation. As an alternative to constructing transmission lines, congestion management can mitigate overload by pre-determined control action. In an example, one option to mitigate post contingency overload is to offset power flow by generation or load. This could involve output control among generators, mega-watt from electric load, and batteries, by integrating online settings to them.

If mitigating control for post-contingency is pre-determined, the transmission capacity as determined by grid constraints can be increased. The transmission constraint can increase generation cost since generators cannot output electricity at the best efficient points. An increased transmission capacity contributes to the reduction of the generation cost and then decreases the electricity price.

In this case, during a normal situation, the power producers in area A can send more power with a lower cost. During an emergency situation, some power producers in area A are ordered to trip their generators to avoid overloading. The transmission switching the action of the grid equipment can increase flow in line Y so as to decrease flow in line X. Transmission switching action could involve transmission topology switching, tap changing of phase transformers, and/or power flow controlling with power electronics devices. The control of power flow can be facilitated by control equipment in a substation, such as a phase shift transformer or transmission switching power flow on line Y.

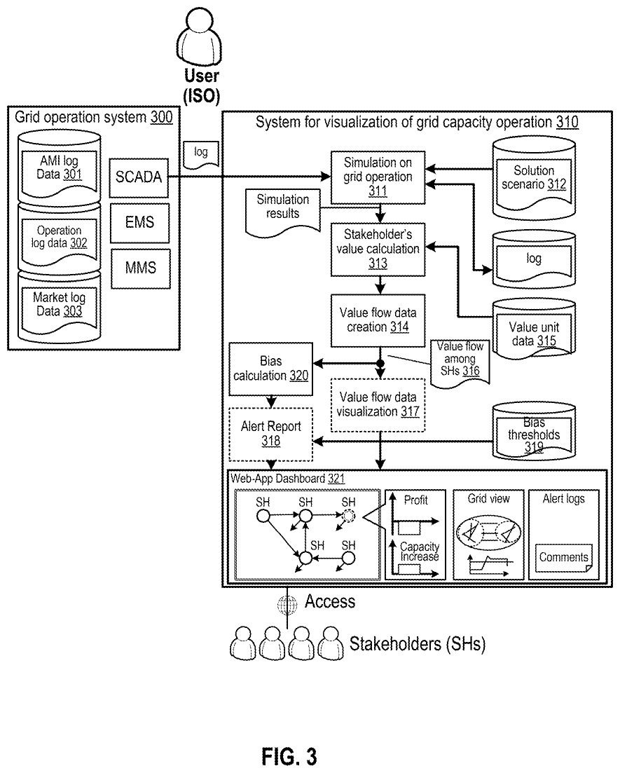

FIG. 3 illustrates a system overview, in accordance with an example implementation. In example implementations described herein, there is a grid operation system 300 and a system for visualization of grid capacity operation 310. The grid operation system 300 can involve various logs depending on the desired implementation, such as but not limited to Advanced Metering Infrastructure (AMI) log data 301, operation log data 302 (e.g., actual operation, planned operation), market log data 303, and so on. Information from such logs can be provided to the system for visualization of grid capacity operation 310 through any desired communication protocol, such as but not limited to Supervisory control and data acquisition (SCADA), Energy Management System (EMS), Market Management System (MMS), and so on.

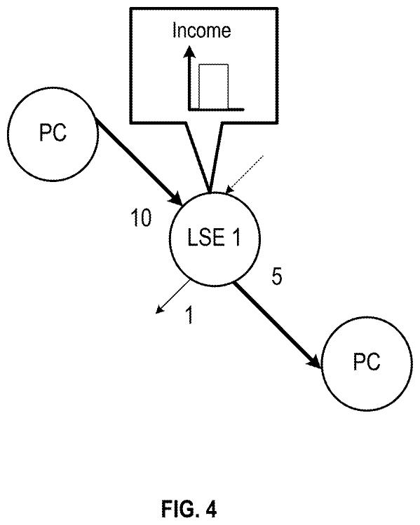

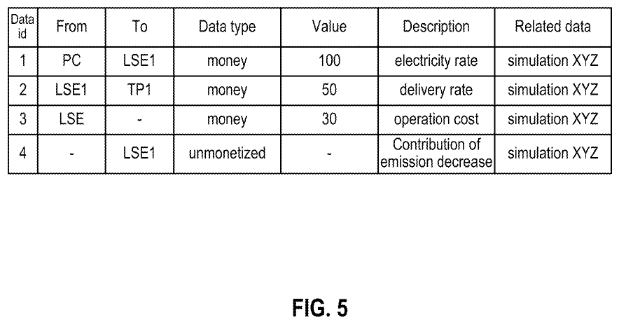

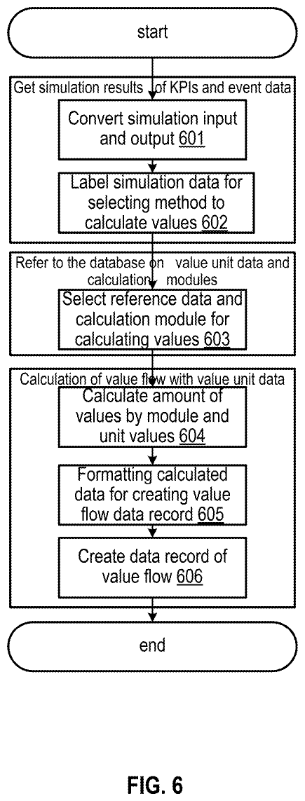

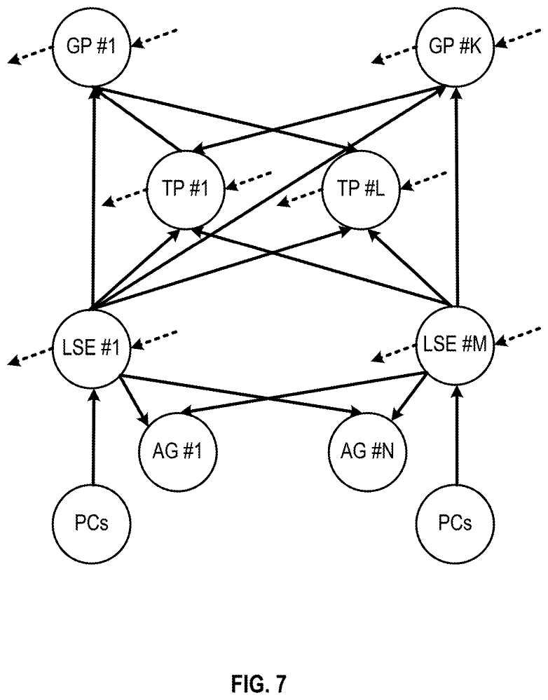

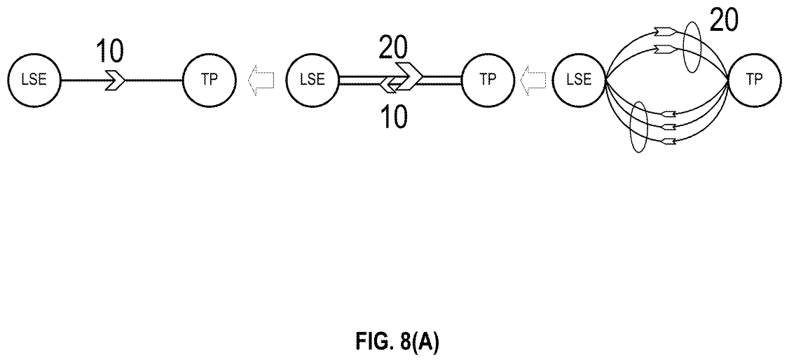

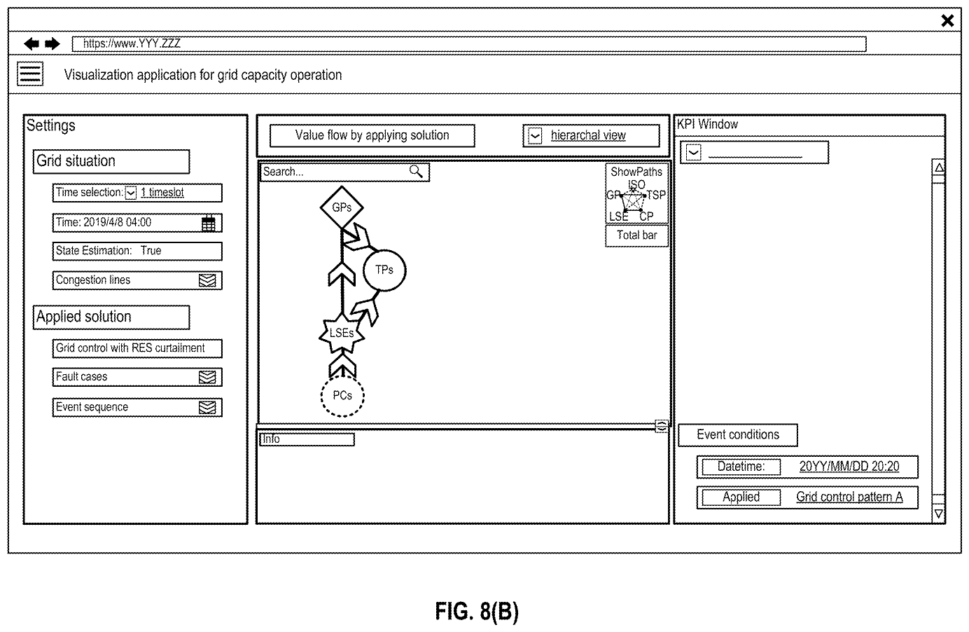

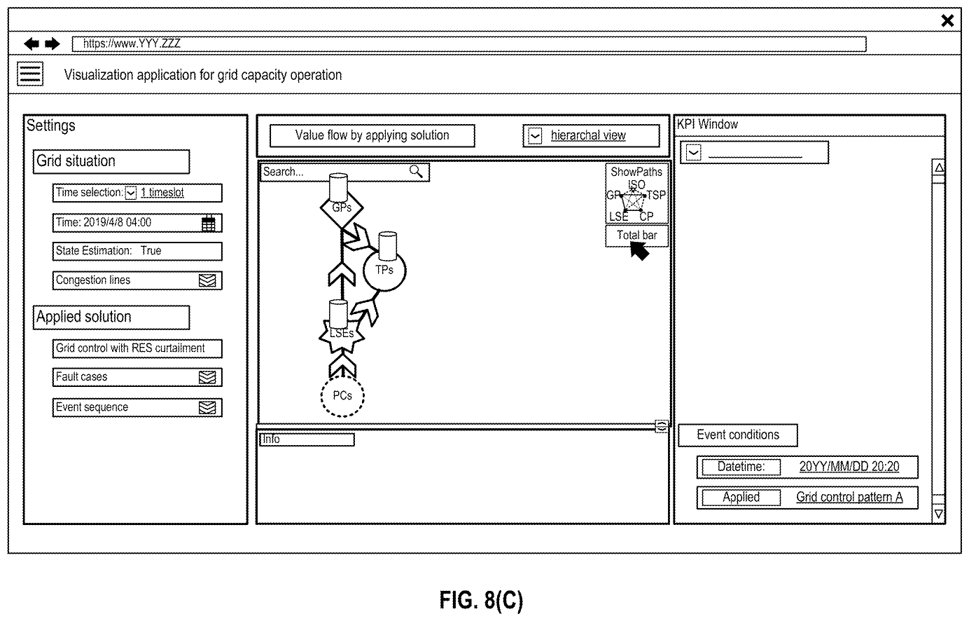

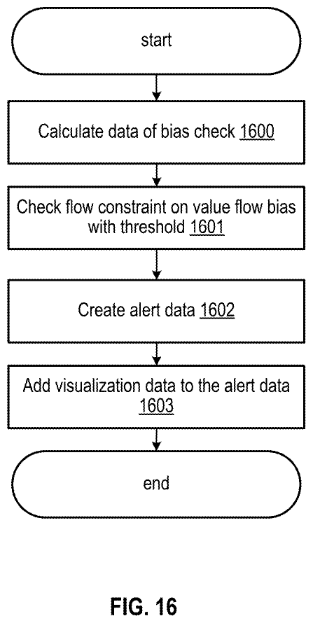

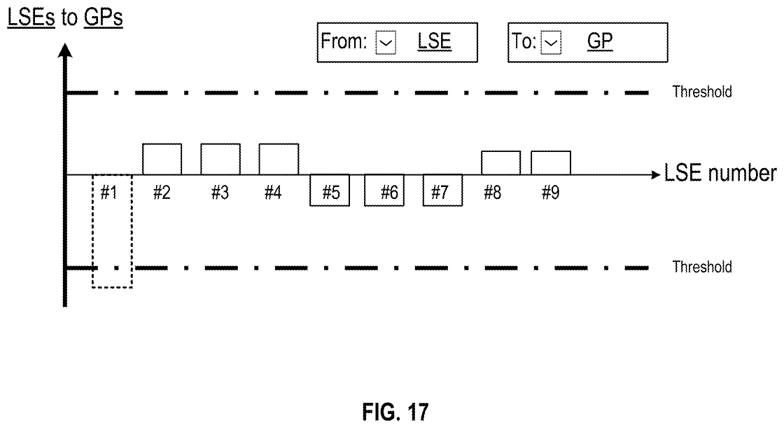

The system for visualization of grid capacity 310 can involves simulation on grid operation 311, solution scenario 312, stakeholder's value calculation 313, value flow data creation 314, value unit data 315, value flow among stakeholders 316, value flow data visualization 317, alert report 318, bias thresholds 319, bias calculation 320, and web-application dashboard 321. The simulation on grid operation 311 involves the execution of simulations as described in FIGS. 5 and 6 to provide simulation results, to provide results for use in the stakeholder's value calculation 313, and to generate logs of the simulation based on sokition scenarios 312, logs, and value unit data 315. Solution scenarios 312 can involve historical or programmed scenarios to be simulated. Stakeholder's value calculation 313 is a function to determine the stakeholder value for various flows based on the value unit data 315 as described with respect to FIG. 4. The output of the stakeholder's value calculation 313 involves the value flow among shareholders 316, which is used for value flow data visualization 317 as illustrated in FIGS. 7 to 17, and for bias calculation 320 as described in FIG. 16. Based on the preset bias thresholds 319, an alert report 318 can also be provided as described with respect to FIG. 17. The alert report 318 and value flow data visualization 317 can be provided to the web application dashboard 321, examples of which are illustrated in FIGS. 8(A) to 15.

FIG. 4 illustrates an example overview of a value flow for a stakeholder, in accordance with an example implementation. Example implementations described herein involve control solution that could provide value transfer among stakeholders. Some parts are formulated as a market, but there are other parts which are not authorized as markets. There are two types of value: monetary value and unmonetized value such as reduction of greenhouse gas emission. Additionally, unmonetized/non-quantitative pros and cons can be are shown as inflow and outflow.

As illustrated in FIG. 4, the system handles these kinds of value flows among stakeholders by one-way paths. This path shows value transfer from a stakeholder to another stakeholder such as payment of money. For each stakeholder, its profit can be calculated by adding all inflows and outflows of money.

The stakeholder's merit can be calculated by

(Stakeholder's merit on money)=Σ−(Value of inflowing line)−Σ−(Value of outflowing line)

Internal cost and income on the operation is defined as value flow to and from other stakeholders. Monetary values of applying the solution can be calculated by comparing money flow between no solution case (current case) and case with the solution.

FIG. 5 illustrates an example data table for the value flow, in accordance with an example implementation. In this example, the value flow data has information on the source stakeholder which provides the value (“from”), and the sink stakeholder which receives the value (“to”), the value amount, the data type, and so on. The data record can include a description of the data such as data type, the value, the description, the related simulation data, and so on depending on the desired implementation.

FIG. 6 illustrates an overview of the value flow creation, in accordance with an example implementation. In the example of FIG. 6, value flow data is created based on the simulation results. The simulations are run for the past case with historical data or for the future case with artificial data forecasted by historical data and grid planning data. This system searches the value unit data from the database for the calculation of the value for control event. When the system cannot calculate the amount of value flow by simulation directly, this system estimates the amount of value flow by using the typical unit data for index and the amount of index calculated by simulation results (e.g. loss by curtailment, loss by switching, profit from the capacity increase).

For costs that cannot be obtained from data and simulation models of power grids and power markets, a pre-modeled cost calculation module can be used (e.g. a unit cost derived from internal process is referred from historical or estimated or pre-input data). The flow conducts labeling on the stakeholder of each value flow and adds related data such as data types and description of the data. Finally, this feature outputs the value flow data to on the grid operation solution events for capacity increase.

As shown in FIG. 6, the first aspect of the flow is to get simulation results of the Key Performance Indicators (KPIs) and event data. Such an aspect involves, at 601, to convert simulation input and output to data for processing. At 602, the flow labels the simulation data for selecting the method to calculate the KPI values. The second aspect of the flow is to refer to the database for the value unit data and calculation modules. This aspect involves, at 603, to select the reference data and calculation module for calculating values from the available modules and reference data illustrated in FIG. 3. The third aspect of the flow is the calculation of value flow with value unit data. This aspect involves, at 604, to calculate the amount of values by module and unit values, formatting calculated data for creating value flow data record at 605, and to create the data record of the value flow at 606.

FIG. 7 illustrates an example of value flow visualization, in accordance with an example implementation. On the top level this system shows the value flow on the group for each stakeholder's business type. This flow shows the relationships among the stakeholder group. Ordinarily, among generation provider (GPs), transmission providers (TPs), load service providers (LSEs), and aggregators (AGs), there are value flow paths on the money payment scheme hierarchy such as that shown in FIG. 7. if there are a plurality of value flows between two stakeholders, then the flow can be shown as one arrow. When the summation data is shown, the arrowhead is directed in the positive.

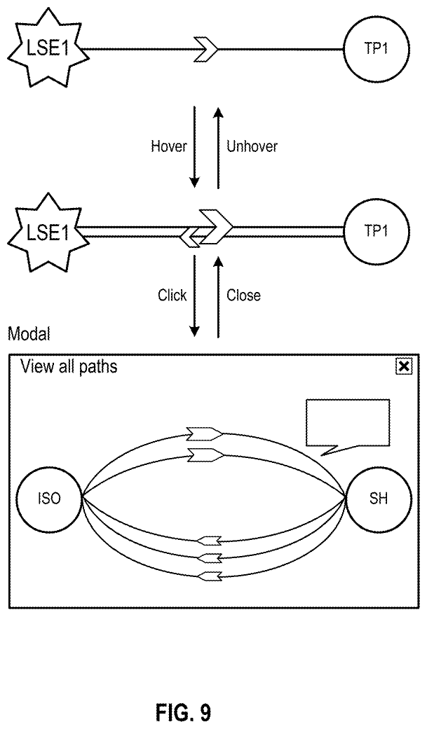

FIG. 8(A) to 8(C) illustrates an example simplification of the value flow visualization on the dashboard, in accordance with an example implementation. As shown in FIG. 8(A), these data also can be processed to visualize as two arrows for totals in each of the two directions, and all paths. A flow path is expanded in the dashboard when the user clicks the summation arrow as shown in FIG. 9. FIG. 8(B) illustrates an example dashboard for the web-based application with the simplified value flow visualization. In the example of FIG. 8(B), the simplified value flow visualization involves the simplified visualization of aggregated value flows, in which stakeholders are aggregated as one node in the visualization. FIG. 8(C) illustrates the dashboard of FIG. 8(B), in which the profits made by the stakeholder group are overlaid on the simplified value flow visualization.

FIG. 9 illustrates an example visualization on path between two stakeholders, in accordance with an example implementation. By having the visualization function, users can see the value flow on the dashboard even if there are many paths between stakeholders. To display such data, the number of stakeholders can cause the visualization to become too cluttered on the screen, and ultimately cause the web browser to crash. Thus, for visual differentiation, the same hierarchy stakeholders can be shown as the same icon in a simplified visualization.

As illustrated in FIG. 9, there is a simplified view that is provided when the cursor or other selection tool is not hovered on the interface in which a single value flow is provided. When the cursor or other selection tool hovers on the simplified view, the visualization can change to illustrate the aggregated value flows from one group to the other (e.g., from LSE1 to TP1, or from TP1 to LSE1). When the visualization is selected, either by a click of the mouse or selection by the selection desired tool, a pop-up window illustrating individual flows between the groups can be provided, which can be closed by the same click of the mouse or selection by the selection tool to return back to the aggregated value flows.

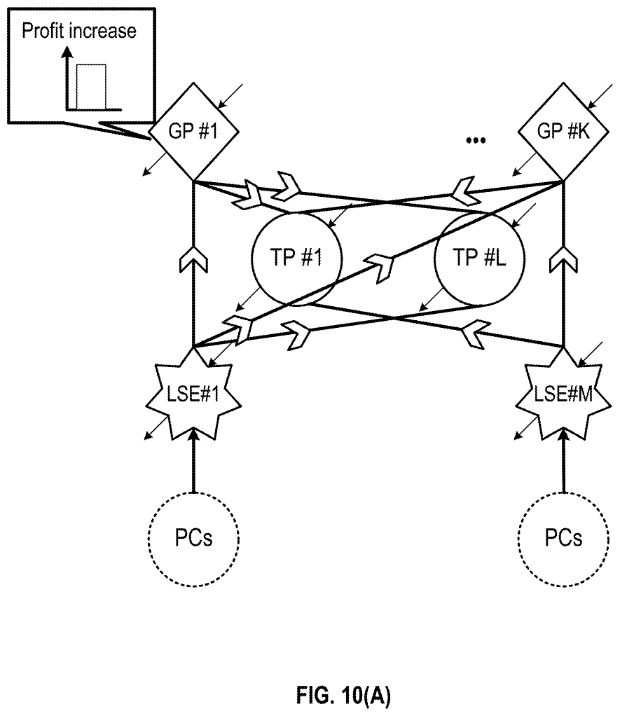

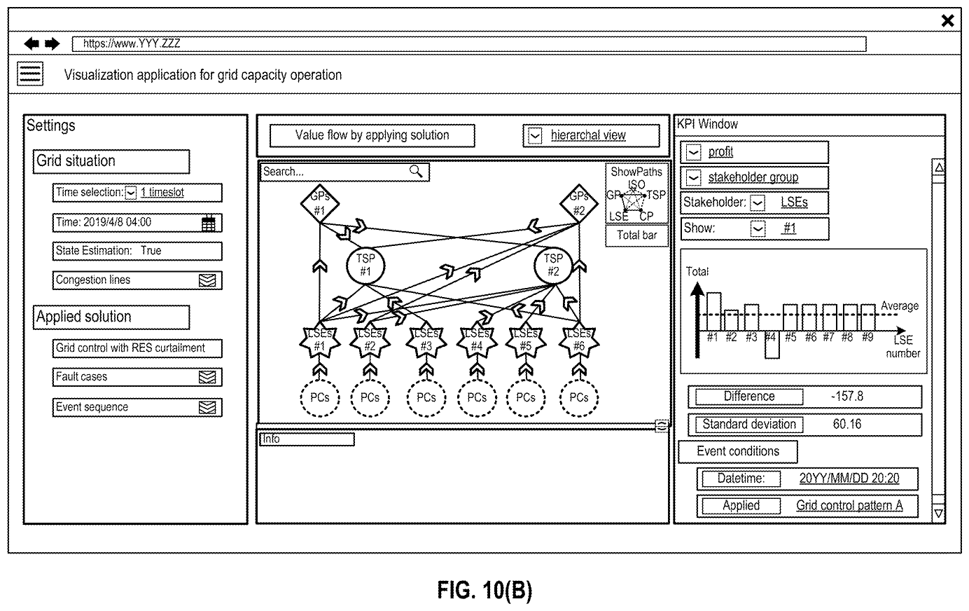

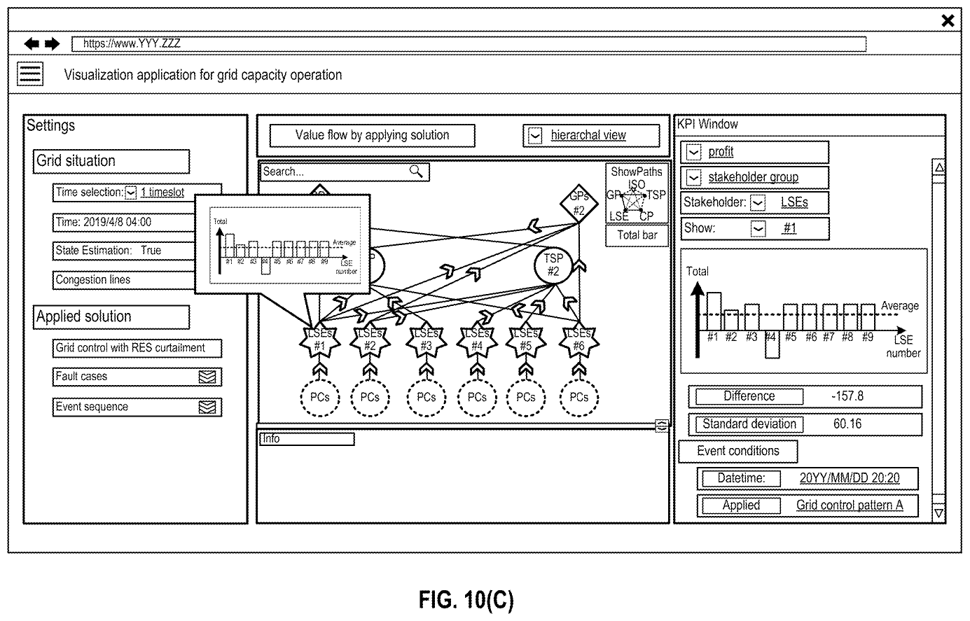

Thus, the increase or decrease of shareholder profit can be shown as a bar chart in a popup near the icons by applying the grid solution. FIGS. 10(A) to 10(C) illustrate a visualization of a hierarchical view of value flows, in accordance with an example implementation. Specifically, FIG. 10(A) illustrates an example of the popup barchart. FIG. 10(B) illustrates an example dashboard upon which the visualization of FIG. 10(A) can be implemented. Upon selection by a mouse click or by hovering a mouse cursor or other desired selection implementation, the pop up with the barchart can be provided as illustrated in FIG. 10(C).

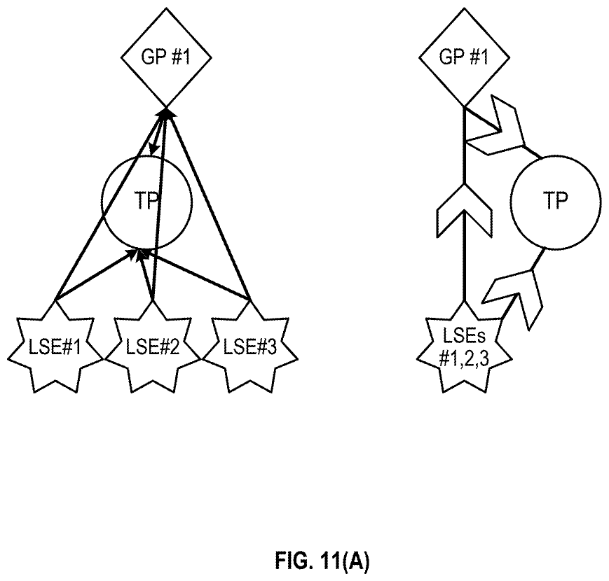

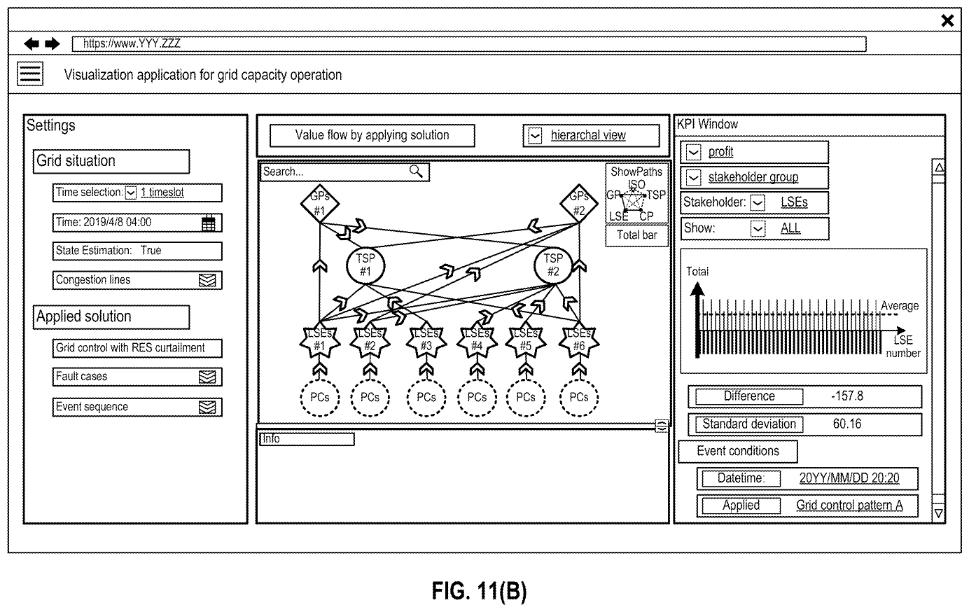

FIGS. 11(A) and 11(B) illustrate an example aggregation of value flows, in accordance with an example implementation. If there are same paths to TP and GP among LSEs this can be aggregated to one icon and paths as shown in FIG. 11(A). The aggregated icon can be separated when the icon is clicked. FIG. 11(B) illustrates an example of a dashboard upon which the aggregation of value flows of FIG. 11(A) can be implemented.

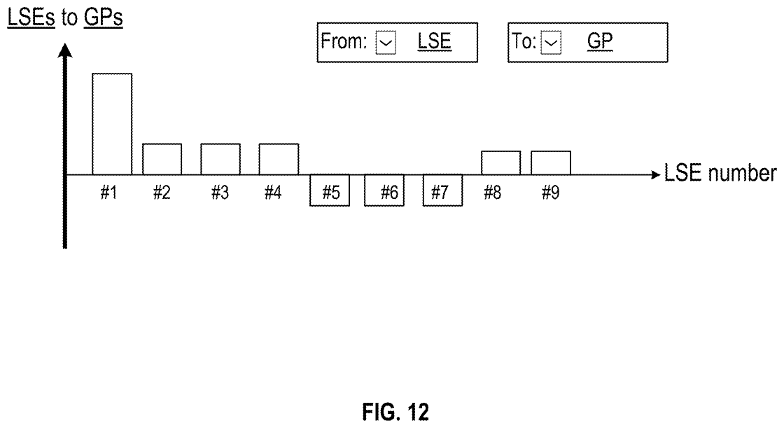

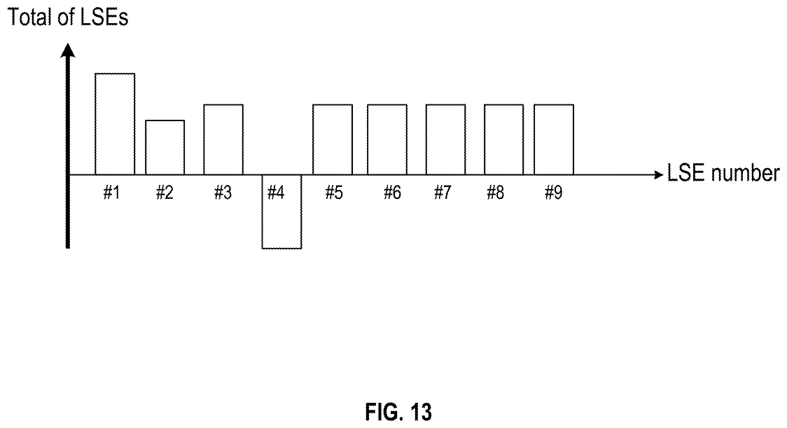

FIGS. 12 and 13 illustrate a comparison view of a flow amount among stakeholders, in accordance with an example implementation. For comparison of stakeholders' merit, the value flow amount can be lined up by A) within a stakeholder group, and B) between stakeholder groups. For A, the system shows stakeholders within the same business domain such as LSE as shown in FIG. 12.

On this view, the system shows the total income by adding flow data as mentioned above. For B), when the user selects “from” and “to” of the stakeholder group, the system shows total value flow from the LSEs to GPs on the dashboard as shown in FIG. 13. Value flow data to be shown can be selected by column of stakeholder from and to in a value flow data record. The groups can be selected through any interface function in accordance with the desired implementation, such as but not limited to drag and select with a mouse, a drag gesture from a touch screen, and so on.

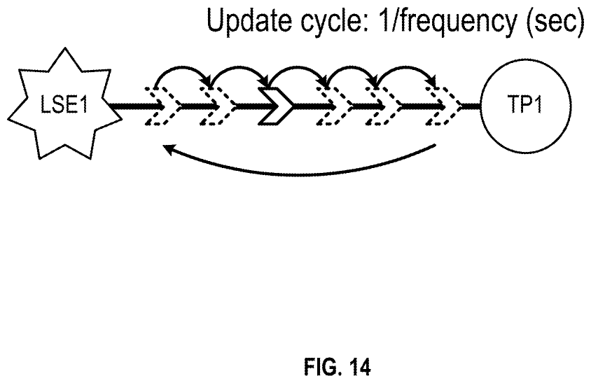

FIG. 14 illustrates an example flow animation, in accordance with an example implementation. A flow animation can allow the user to understand the directions and amount of the flows. For example, the movement of the arrowhead between edges of the path line can be animated as illustrated in FIG. 14. For flow animation on web browsers, it can be difficult to draw arrows dynamically on thousands of elements without freeze or delay.

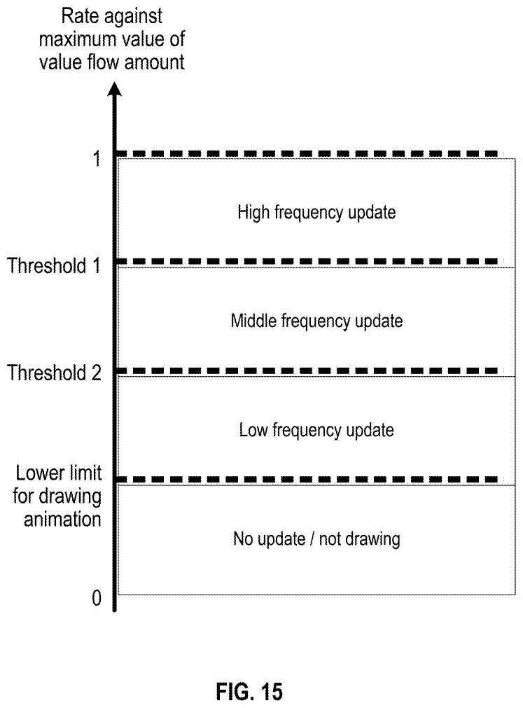

FIG. 15 illustrates the flow animation cycle, in accordance with an example implementation. For the lightening processes, the system changes the update cycle of animation based on amount of value flow and thresholds and lower limit to draw. By changing the update cycle, the system can show the flow animation smoothly on the web browser of users. The thresholds can be set in accordance with the desired implementation for having no update, low frequency update, the medium frequency update, and high frequency update.

FIG. 16 illustrates an example of the bias calculation flow, in accordance with an example implementation. In this function block, the system calculates data of the bias check for the constraint violation check based on the equation or data value from the value flow data at 1600 and checks constraints on the value flow data at 1601. The values can be the flow amount, the flow amount on a certain type of control, the variance among stakeholders in a group such as GPs, and so on. If such data exceed thresholds input beforehand by users, then alert data is created at 1602 and the alert data is published as a visualization at 1603.

FIG. 17 illustrates an example of the bias visualization, in accordance with an example implementation. If the alert data is published, then the system can create alert data indicative of the event and the violated constraint, along with the degree of the violation. The alert can be shown visual effects on the Graphical User Interface (GUI) dashboard such as color change or blinking, or dash lines as illustrated in FIG. 17, the alert also can be sent as notification messages to the value flow dashboard, or issue report pages that stakeholders can view. By showing the alert, the stakeholders can know the biased merits and demerits.

Further, if a biased merit or demerit is alerted, then the system could show an alternative solution to mitigate the bias by showing a pop-up window, or otherwise in accordance with the desired implementation. This can be provided by calculating the value flows on other solution backgrounds and ranking of the effect of solutions by bias values or other KPIs. By having the sensitivity of the change of the value flow to the perturbation of the controlled quantity obtained by the simulation, the calculation can be realized by solving the mathematical programming problem that instructs the operation of the elements of the system.

When a large congestion event occurs, the system can store log data from the grid operation system such as SCADA/EMS/MMS with high resolution and situational data such as weather forecast data. This can support an analysis effect of new solutions for important situations from the past, and decrease data storage size for logging.

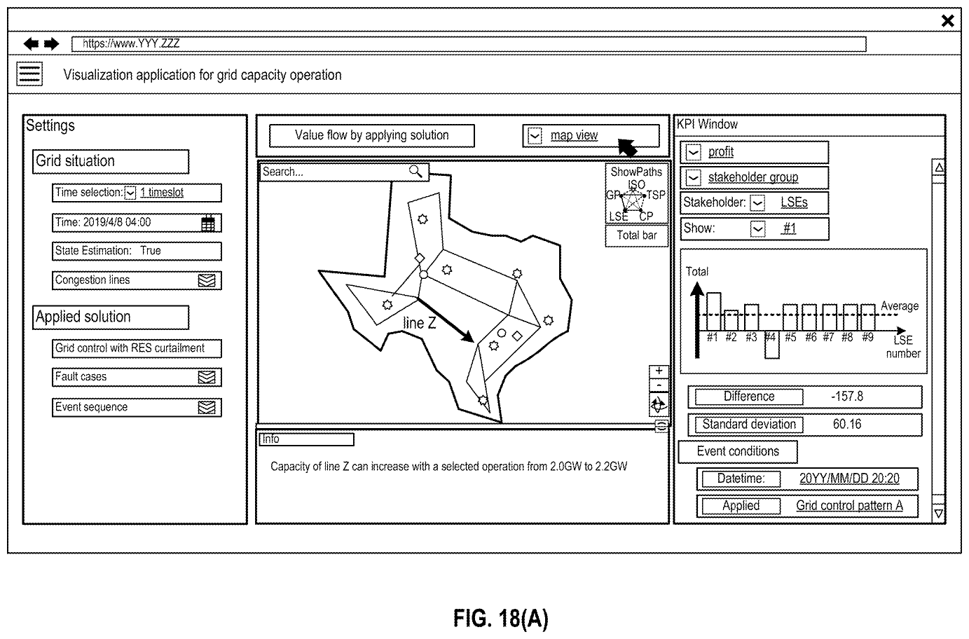

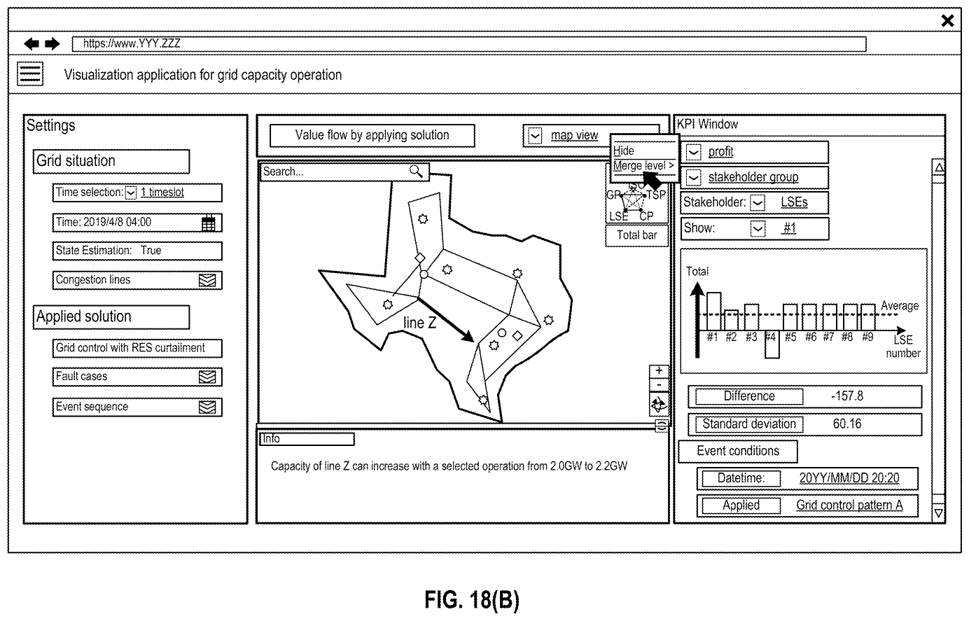

FIG. 18(A) and 18(B) illustrate a map view of the dashboard, in accordance with an example implementation. In the examples of FIGS. 18(A) and 18(B), The path from PCs to LSE can be omitted for visualization and integrated to the inflow of the LSE. There are many stakeholders in a grid (e.g. Texas). TP: Transmission lines are owned by more than 25, LSE: There are more than 300 LSEs, GP: There are more than 550 resource entities.

Example implementations described herein can facilitate a visualization system for value of stakeholder on new solutions, an awareness system for the transmission grid operator on the grid capacity management, and a decision supporting system for the grid operator on measures to increase capacity under grid stable control.

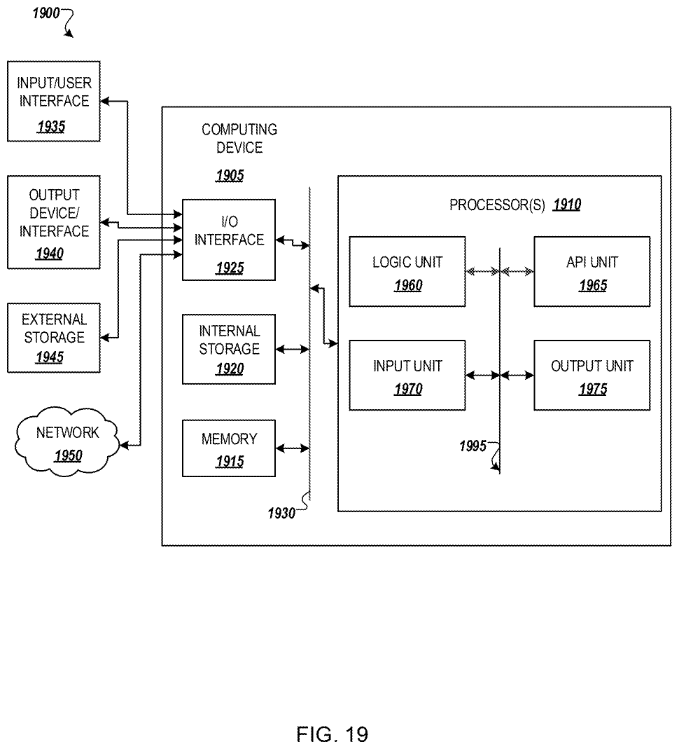

FIG. 19 illustrates an example computing environment with an example computer device suitable for use in some example implementations. Computer device 1905 in computing environment 1900 can include one or more processing units, cores, or processors 1910, memory 1915 (e.g., RAM, ROM, and/or the like), internal storage 1920 (e.g., magnetic, optical, solid state storage, and/or organic), and/or I/O interface 1925, any of which can be coupled on a communication mechanism or bus 1930 for communicating information or embedded in the computer device 1905. I/O interface 1925 is also configured to receive images from cameras or provide images to projectors or displays, depending on the desired implementation.

Computer device 1905 can be communicatively coupled to input/user interface 1935 and output device/interface 1940. Either one or both of input/user interface 1935 and output device/interface 1940 can be a wired or wireless interface and can be detachable. Input/user interface 1935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1940 may include a display, television, monitor, printer, speaker, braille, or the like. In some example implementations, input/user interface 1935 and output device/interface 1940 can be embedded with or physically coupled to the computer device 1905. In other example implementations, other computer devices may function as or provide the functions of input/user interface 1935 and output device/interface 1940 for a computer device 1905.

Examples of computer device 1905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1905 can be communicatively coupled (e.g., via I/O interface 1925) to external storage 1945 and network 1950 for communicating with any number of networked components, devices, and systems, including one or more computer devices of the same or different configuration. Computer device 1905 or any connected computer device can be functioning as, providing services of, or referred to as a server, client, thin server, general machine, special-purpose machine, or another label.

I/O interface 1925 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1900. Network 1950 can be any network or combination of networks (e.g., the Internet, local area network, wide area network, a telephonic network, a cellular network, satellite network, and the like).

Computer device 1905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1910 can execute under any operating system (OS) (not shown), in a native or virtual environment. One or more applications can be deployed that include logic unit 1960, application programming interface (API) unit 1965, input unit 1970, output unit 1975, and inter-unit communication mechanism 1995 for the different units to communicate with each other, with the OS, and with other applications (not shown). The described units and elements can be varied in design, function, configuration, or implementation and are not limited to the descriptions provided. Processor(s) 1910 can be in the form of hardware processors such as central processing units (CPUs) or in a combination of hardware and software units.

In some example implementations, when information or an execution instruction is received by API unit 1965, it may be communicated to one or more other units (e.g., logic unit 1960, input unit 1970, output unit 1975). In some instances, logic unit 1960 may be configured to control the information flow among the units and direct the services provided by API unit 1965, input unit 1970, output unit 1975, in some example implementations described above. For example, the flow of one or more processes or implementations may be controlled by logic unit 1960 alone or in conjunction with API unit 1965. The input unit 1970 may be configured to obtain input for the calculations described in the example implementations, and the output unit 1975 may be configured to provide output based on the calculations described in example implementations.

Processor(s) 1910 can be configured to execute a method or instructions involving calculating revenue gain or loss between stakeholders on grid operations based on logs (e.g., historical data) associated with a grid and simulations executed on the grid; and generating a visualization of value flow paths between the stakeholders associated with the revenue gain or loss, the generating the visualization comprising consolidating value flows paths between pairs of stakeholders into a simplified representation as illustrated in FIGS. 8(A) to 8(C).

Processor(s) 1910 can be configured to execute a method or instructions involving generating alerts on the visualization for a revenue gain or loss to one or more stakeholders being more than a threshold as illustrated in FIG. 17.

Processor(s) 1910 can be configured to execute a method or instructions as described herein, wherein the logs associated with the grid comprise historical data of payment managed in storage, the historical data of payment indicative of input and output of the stakeholders to the grid; wherein the calculating of the revenue gain or loss between stakeholders is based on the input and the output of the stakeholders to the grid from the historical data of payment as illustrated in FIG. 7.

Processor(s) 1910 can be configured to execute a method or instructions as described herein, which can also involve, for detection of a cursor hovered over one of the value flow paths, providing a popup indicative of a value flow associated with the one of the value flow paths as illustrated in FIG. 6.

Processor(s) 1910 can be configured to execute a method or instructions as described herein, and further involve for a detection of a use of an interface function to select of a consolidated group formed from the stakeholders, displaying the revenue gain or loss for the consolidated group of stakeholders as described in FIGS. 12 and 13.

Processor(s) 1910 can be configured to execute a method or instructions as described herein, visualization comprises one or more visualizations of the revenue gain or loss, the one or more visualizations comprising one or more of a first visualization indicating the revenue gain or loss for each of the stakeholders in the grid as illustrated in FIG. 14; and a second visualization indicating the revenue gain or loss of one of the stakeholders of the grid responsive to a selection of the one of the stakeholders as illustrated in FIG. 4.

Processor(s) 1910 can be configured to execute a method or instructions as described herein, wherein the simplified representation comprises consolidating ones of the value flow paths between same pairs of stakeholders into a single value flow path on the visualization as illustrated in FIG. 9.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

1. A method, comprising:
calculating, by a processor, revenue gain or loss between stakeholders on grid operations based on logs associated with a grid and simulations executed on the grid;
generating, by the processor, a visualization of value flow paths between the stakeholders associated with the revenue gain or loss, the generating the visualization comprising consolidating value flows paths of real-time operation between pairs of stakeholders into a simplified representation for realizing economic pros and cons among stakeholders and to illustrate biasing among stakeholders;
for detection of biasing among stakeholders, generating alternative proposal to mitigate the detected biasing among stakeholders to prevent overload; and
for detection of a cursor hovered over the simplified representation and without requiring the cursor to select the simplified representation, providing, by the processor, visualization of aggregated value flow paths between the pairs of stakeholders, wherein the aggregated value flow paths comprise at least two directional summation indicators.

2. The method of claim 1, further comprising generating, by the processor, alerts on the visualization for a revenue gain or loss to one or more stakeholders being more than a threshold.

3. The method of claim 1, wherein the logs associated with the grid comprise historical data of payment managed in storage, the historical data of payment indicative of input and output of the stakeholders to the grid;
wherein the calculating of the revenue gain or loss between stakeholders is based on the input and the output of the stakeholders to the grid from the historical data of payment.

4. The method of claim 1, further comprising:
for detection of a cursor hovered over one of the value flow paths, providing, by the processor, a popup indicative of a value flow associated with the one of the value flow paths.

5. The method of claim 1, further comprising, for a detection of a use of an interface function to select of a consolidated group formed from the stakeholders, displaying the revenue gain or loss for the consolidated group of stakeholders.

6. The method of claim 1, wherein the visualization comprises one or more visualizations of the revenue gain or loss, the one or more visualizations comprising one or more of:
a first visualization indicating the revenue gain or loss for each of the stakeholders in the grid;
a second visualization indicating the revenue gain or loss of one of the stakeholders of the grid responsive to a selection of the one of the stakeholders.

7. The method of claim 1, wherein the simplified representation comprises consolidating ones of the value flow paths between same pairs of stakeholders into a single value flow path on the visualization.

8. A non-transitory computer readable medium, storing instructions for executing a process, the instructions are performed by a processor, the instructions comprising:
calculating revenue gain or loss between stakeholders on grid operations based on logs associated with a grid and simulations executed on the grid;
generating a visualization of value flow paths between the stakeholders associated with the revenue gain or loss, the generating the visualization comprising consolidating value flows paths of real-time operation between pairs of stakeholders into a simplified representation for realizing economic pros and cons among stakeholders and to illustrate biasing among stakeholders;
for detection of biasing among stakeholders, generating alternative proposal to mitigate the detected biasing among stakeholders to prevent overload; and
for detection of a cursor hovered over the simplified representation and without requiring the cursor to select the simplified representation, providing visualization of aggregated value flow paths between the pairs of stakeholders, wherein the aggregated value flow paths comprise at least two directional summation indicators.

9. The non-transitory computer readable medium of claim 8, the instructions further comprising generating alerts on the visualization for a revenue gain or loss to one or more stakeholders being more than a threshold.

10. The non-transitory computer readable medium of claim 8, wherein the logs associated with the grid comprise historical data of payment managed in storage, the historical data of payment indicative of input and output of the stakeholders to the grid;
wherein the calculating of the revenue gain or loss between stakeholders is based on the input and the output of the stakeholders to the grid from the historical data of payment.

11. The non-transitory computer readable medium of claim 8, further comprising:
for detection of a cursor hovered over one of the value flow paths, providing a popup indicative of a value flow associated with the one of the value flow paths.

12. The non-transitory computer readable medium of claim 8, further comprising, for a detection of a use of an interface function to select of a consolidated group formed from the stakeholders, displaying the revenue gain or loss for the consolidated group of stakeholders.

13. The non-transitory computer readable medium of claim 8, wherein the visualization comprises one or more visualizations of the revenue gain or loss, the one or more visualizations comprising one or more of:
a first visualization indicating the revenue gain or loss for each of the stakeholders in the grid;
a second visualization indicating the revenue gain or loss of one of the stakeholders of the grid responsive to a selection of the one of the stakeholders.

14. The non-transitory computer readable medium of claim 8, wherein the simplified representation comprises consolidating ones of the value flow paths between same pairs of stakeholders into a single value flow path on the visualization.

15. An apparatus, comprising:
a processor, configured to:
calculate revenue gain or loss between stakeholders on grid operations based on logs associated with a grid and simulations executed on the grid; and
generate a visualization of value flow paths between the stakeholders associated with the revenue gain or loss, the generating the visualization comprising consolidating value flows paths of real-time operation between pairs of stakeholders into a simplified representation for realizing economic pros and cons among stakeholders and to illustrate biasing among stakeholders;
for detection of biasing among stakeholders, generate alternative proposal to mitigate the detected biasing among stakeholders to prevent overload:, and
for detection of a cursor hovered over the simplified representation and without requiring the cursor to select the simplified representation, providing visualization of aggregated value flow paths between the pairs of stakeholders, wherein the aggregated value flow paths comprise at least, two directional summation indicators.
